(19) United States
(12) Patent Application Publication
(10) Pub. No.: US 2006/0097651 A1
(43) Pub. Date: May 11, 2006

(54) Supply apparatus for high pressure lamps

(76) Inventors: Winston Couwenberg, Eindhoven (NL); Ronald Hans Van Der Voort, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,901

(22) PCT Filed: Dec. 2, 2003
(86) PCT No.: PCT/IB03/05694

§ 371 Date: Jun. 16, 2005

(30) Foreign Application Priority Data
Dec. 20, 2002 (EP) 02080504.0

(51) Int. Cl. H05B 39/04

(52) U.S. Cl. 315/209 R

(57) ABSTRACT

The invention relates to an apparatus for supplying electrical energy at high frequencies to HID-lamps, comprising at least a first high frequency voltage source adapted to generate a substantial sinusoidal voltage with a fist frequency and a first amplitude, at least a first piezoelectric transformer of which the resonance frequency is substantially equal to the first frequency and which is connected to said first voltage source, a number of secondary voltage sources which are each adapted to generate a substantial sinusoidal voltage with a frequency which is an odd harmonic of the first frequency and an amplitude which is an odd fraction of the first amplitude and a number of piezoelectric transformers of which the connected to the second voltage source.

The invention relates to an apparatus for supplying electrical energy at high frequencies to HID-lamps, the apparatus comprising at least a first high frequency voltage source adapted to generate a substantial sinusoidal voltage with a first frequency and a first amplitude and at least a first piezoelectric transformer of which the resonance frequency is substantially equal to the first frequency and which is connected to said first voltage source.

Such an apparatus is known from the publication by H. Kadedhashi, Electronic ballast using piezoelectric transformers for fluorescent lamps, IEEE PESC98.

A piezoelectric transformer is formed by a piezoelectric crystal with two pairs of electrodes or by two mechanically coupled piezoelectric elements with a pair of electrodes each.

Application an AC voltage over a first pair of electrodes will lead to mechanical oscillation of the piezoelectric element. As a consequence thereof an AC voltage will be developed on the other pair of electrodes. By appropriate dimensioning of the relevant parts, the ratio between the two voltages can be determined.

The use of piezoelectric transformers for fluorescent lamps is advantageous as the use of piezoelectric elements allows a substantial reduction of the size of the ballast, avoids the use of a separate ignition unit, increases the efficiency of the ballast and allows a higher operating temperature.

Nevertheless the use of these piezoelectric transformers does not alleviate the disadvantage of acoustical resonance in the lamp itself which may lead to destruction of the lamp.

The aim of the invention is to provide such a supply apparatus for a HID lamp in which the problems with acoustical resonance are alleviated.

This aim is reached by such an apparatus comprising a number of secondary voltage sources which are each adapted to generate a substantial sinusoidal voltage with a frequency which is an odd harmonic of the first frequency and an amplitude which is an odd fraction of the first amplitude and comprising a number of piezoelectric transformers each of which being connected to one of the secondary voltage sources.

The use of secondary voltage sources of which the frequencies are odd multiples of the frequency of the first voltage source and of which the amplitudes are odd fractions of the amplitude of the first voltage source forms an approximation of a Fourier synthesis of a square wave. For the generation of acoustic resonance the power spectrum is relevant. The power spectrum of a square wave is flat, so that excitations of the acoustic oscillations are avoided.

In JP-A-11 354 857 a power supply device is disclosed which makes use of Fourier synthesis for generating a non sinusoidal periodic voltage to supply power to a load. This is a general application document in which the problems of acoustic resonance of high pressure gas discharge lamps is not addressed.

It is noted that in practice only a limited number of secondary voltage sources can be provided, making the square wave less than perfect. Hence the power spectrum will not be flat completely so that not all excitations are avoided.

Under the information now available it appears that one first voltage source, two secondary voltage sources and three piezoelectric transformers would lead to an apparatus with an optimal relation between production costs and efficiency.

As stated before, the practical limitations of the number of voltage sources and transformers leads to an imperfect square wave which alleviates the problems of acoustical resonance in the lamp, but which does not completely avoids these problems.

To avoid those problems a further preferred embodiment of the invention provides the feature that the voltage sources are adapted to modulate their frequencies, wherein the relation between the frequencies of the first and the secondary voltage sources is maintained.

The modulation of the frequencies avoids the constant presence of a frequency, which may reside within the frequency range in which the acoustic resonance may be excited. The modulation provides in a continuous change of the frequency so that the power spectrum of the modulated signal is spread over a wide area. This makes the power within the frequency range in which excitation may occur low. By a suitable choice of parameters it may be possible to keep the power within the range beneath a threshold above which acoustic resonance may occur.

Another matter which should be noted is the frequency-amplitude transfer characteristic of the piezoelectric transformers. These transformers have a rather pronounced frequency response, that is that on both sides of the frequency wherein resonance within the crystal occurs, the flanks of the frequency characteristic are steep. This implies that even a small variation in frequency will result in a substantial decrease of voltage and power on the secondary side of the transformer.

Subsequently the invention will be elucidated with the help of the accompanying drawings, which show:

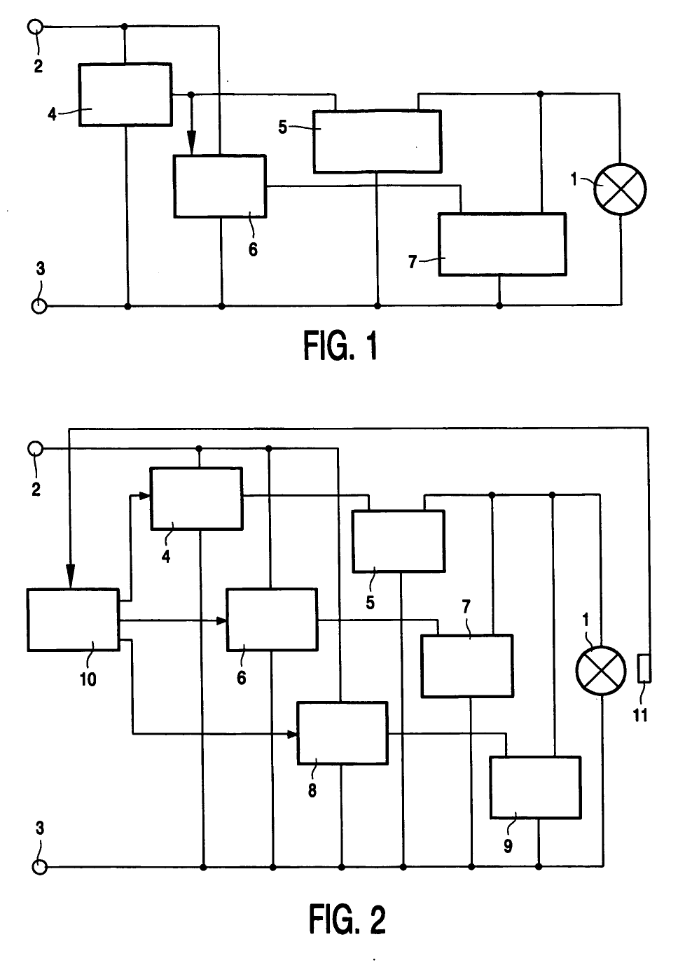

FIG. 1: a diagram of a circuit according to a first embodiment of the invention; and

FIG. 2: a diagram of circuit according to a second embodiment of the invention.

FIG. 1 shows a high pressure gas discharge lamp, which is to be powered by a power supply, such as a mains power supply, comprising a power connection 2 and a neutral connection 3.

To take advantage of the high frequency power supply, like small size and high efficiency, the circuit comprises a high frequency generator 4, which is adapted to generate a signal with a basic frequency f_{b}. The output of this generator is connected to an input of a piezoelectric transformer 5. The output of the piezoelectric transformer 5 is connected to the lamp 1.

The circuit as described so far is according to the prior art.

The invention provides a second generator 6, which is adapted to generate an output signal with a frequency which is three times the frequency of the first generator 4, that is 3 f_{b} and of which the amplitude is one third of the amplitude of the signal generated by the first generator 4. To maintain the frequency and phase relationship between the two generators 4 and 6, the output signal of the first generator is supplied to the second generator. Herein the relation between the two signals is such that added they form a first order approximation of a square wave signal.

The output signal of the second generator is fed to a second piezoelectric transformer 7, and the output signal thereof is added to the output signal of the first piezoelectric transformer 5. The resulting added output signal is an approximation of square wave signal. A square wave signal has a flat power spectrum, so that acoustic resonance in the lamp is avoided to some extend.

As stated in the introduction this is a first embodiment of the invention enjoying the advantages thereof. It is possible to use more generators and piezoelectric transformers.

FIG. 2 discloses an embodiment in which three generators and three piezoelectric transformers are used. This embodiment comprises, besides the generators of FIG. 1, a third generator 8, of which the frequency is five times the frequency of the first generator 4, that is 5 f_{b} and of which the amplitude is one fifth of the amplitude of the signal generated by the first generator. This gives a closer approximation of the square wave so that a flat power spectrum within the lamp 1 is approximated even more.

The signal from the third generator 8 is supplied to a third piezoelectric transformer 9, of which the output signal is added to added output signals of the first and second generators 5, 7.

Also in this case the relation between frequency and phase of the first, second and third signals is of importance. In this second embodiment a basic generator is provided which supplies a reference signal with frequency f_{b} to each of the first, second and third generators.

To avoid acoustic resonance in the lamp, it is also possible to modulate the frequency of the power supply. In respect it is noted that the provision of a limited number of generators and piezoelectric transformers does only lead to a limited avoidance of acoustic resonance; it may be possible that acoustic resonance develop, despite all precautions. Modulation of the frequency is another feature to avoid acoustic resonance. In this second embodiment this can easily be achieved by modulation of the frequency f_{b} of the output signal of the basic generator.

This modulation may take place according to a predetermined program. In the composition of the program one can use previous experience with lamps of the type, the apparatus is about to supply power to. One should also take account of the frequency dependant behavior of the piezoelectric transformers. Taking these considerations into account, it is attractive to vary the frequency about 5% around the nominal frequency.

It is however also possible to make use of a feedback structure. This structure provides a detector 11 in the vicinity of the lamp, which detector is arranged to detect acoustical resonance in the lamp. The detector may be an acoustical detector. The output signal of the detector is supplied to the basic generator 10, so that this generator may modulate its frequency when the detector 11 detects imminent acoustical resonance.

It will be clear to skilled men that numerous amendments can be made to the present invention without departing from the scope of the invention. It is in particular possible to make use of a larger number of generators and piezoelectric transformers than three.

1. Apparatus for supplying electrical energy at high frequencies to HID-lamps, comprising:
at least a first high frequency voltage source adapted to generate a substantial sinusoidal voltage with a first frequency and a first amplitude;
at least a first piezoelectric transformer of which the resonance frequency is substantially equal to the first frequency and which is connected to said first voltage source, characterized by
a number of secondary voltage sources which are each adapted to generate a substantial sinusoidal voltage with a frequency which is an odd harmonic of the first frequency and an amplitude which is an odd fraction of the first amplitude; and
a number of piezoelectric transformers each of which being connected to one of the second voltage source.

2. Apparatus as claimed in claim 1, characterized in that the number of secondary voltage sources is equal to three.

3. Apparatus as claimed in claim 1, characterized in that the voltage sources are adapted to modulate their frequencies, wherein the relation between the frequencies of the first and the secondary voltage sources is maintained.

4. Apparatus as claimed in claim 3, characterized in that the frequencies are modulated within a range within which the piezoelectric transformers perform their function.

5. Apparatus as claimed in claim 1, characterized in that the frequency of all voltage sources is controlled through a single generator.

6. Apparatus as claimed in claim 3, characterized in that the apparatus comprises a transducer to detect oscillations in a lamp connected to the apparatus, and that the frequency of the voltage generated by the voltage sources is modulated if the transducer detects modulations in the lamp.
